(19) United States
(12) Patent Application Publication
(10) Pub. No.: US 2010/0019028 A1
(43) Pub. Date: Jan. 28, 2010

(54) Affinity group bearer debit cards, and card systems

(75) Inventors: Gregory J. Books, Omro, WI (US); Mark E. Seifert, Menasha, WI (US)

Correspondence Address: WILHELM LAW SERVICE, S.C., 100 W LAWRENCE ST, THIRD FLOOR, APPLETON, WI, 54911, US

(73) Assignee: G&T Management, LLC, Omro, WI (US)

(21) Appl. No.: 12/460,753

(22) Filed: Jul. 24, 2009

Related U.S. Application Data
(60) Provisional application No. 61/137,033, filed on Jul. 25, 2008.

(51) Int. Cl. G07F 19/00; G06K 5/00; G06Q 30/00; G06Q 40/00

(52) U.S. Cl. 235/379; 235/382; 705/14.49; 705/44

(57) ABSTRACT

Systems and methods for transferring money internationally or domestically using conventional financial institution accounts and infrastructure for transfers but using non-conventional procedures to initiate the accounts. Such system comprises a non-financial-institution, non-employer, sponsor; single or multiple remitters, multiple funds recipients, a card processor; financial institution accounts for each remitter and each recipient. A remitter initiates a remittance account for himself, and a recipient account associated with a recipient. A debit card and PIN are linked to the recipient account. Multiple remitters can be affiliated with the sponsor, or a remitter can be the sponsor. The sponsor can be a non-profit. The system may track information into an account, and identify and record sources of funds transferred into the account. The debit card and PIN can access funds at a POS or ATM. Funds are transferred electronically between remitter and recipient accounts, and accessed using the debit card.

### BACKGROUND

This invention relates generally to systems and methods for transferring money using conventional financial institution account and infrastructure but without using conventional financial institution procedures to set up the accounts.

In some instances, the invention relates to remitting money from a remitter in a first country to a recipient in a second country.

In other instances, the invention relates to a processor of unfinished goods remitting money to producers of such unfinished goods as payment for the goods produced.

For example, persons of Hispanic ethnicity send millions of remittance transactions from the United States to Mexico and other Latin American countries every year. A typical remittance system is illustrated in Prior Art FIG. 1.

FIG. 1 shows the typical Western Union® remittance model. The remitter arrives at a Western Union® remittance facility, e.g. in the United States, with sufficient cash to cover the amount of money to be sent, the destination to which the money is to be sent, and sufficient additional cash to pay the various service fees charged by Western Union®.

The remitter pays the cash amount required to complete the transaction, and the attendant at the Western Union® remittance station takes the cash and takes/transcribes the information required to complete the transaction, such information as the remitters identity and the receivers identity and location.

On the basis of the cash and information received at the remittance station, Western Union® credits the remitter with the amount paid, and sends payment instructions to a Western Union® remittance/receiving station at the destination location, for example in Mexico. Western Union® does not notify the recipient that funds are available to be picked up. Rather, it is the remitter's responsibility to notify the recipient that money has been sent and can be picked up. After the recipient becomes aware that money has been sent, the recipient enters the specified Western Union® remittance/receiving station at the destination location and requests payment of the funds sent. The Western Union® agent at the destination location converts the US dollars sent into the local currency, charging an exchange fee, typically 9% of the transaction amount, and a transaction fee. The money remaining, after paying all the fees, is then given to the recipient.

The above transaction process is effective for remitting money from the US to another country so long as a Western Union® facility is suitably located to be accessed both at the remittance end in the US and at the destination end in the second country. For certain countries which experience a substantial number of such transactions, Western Union® has established enough facilities that the system of FIG. 1 is effective to make such transfers routine. However, the transaction costs are very high. Namely, by the time the transaction is completed in the destination country, e.g. Mexico, about 25-30 percent of the money originally received at the remittance station has been spent as transaction fees in moving the money from the US to the second country.

In response to these high costs, one or more banks and one or more card processors (B/CP) have developed alternative services directed to making such remittances to second countries through the conventional banking system. An exemplary such alternative remittance system is illustrated in Prior Art FIG. 2.

In the existing system of FIG. 2, the remitter arrives at a bank facility, e.g. in the United States, with sufficient cash to cover the amount of money to be sent, and sufficient additional cash to pay the various fees charged by the bank.

The bank collects the necessary amount of cash, opens a first bank account in the remitting country, e.g. the US, in the name of the remitter, and opens a second bank account at a branch office of the bank in the second country, in the name of the person (recipient), in the recipient's country e.g. Mexico, who is to receive the money being remitted. This requires the recipient to visit the bank branch in the second country to open the second account, which visit to a bank facility is culturally difficult for persons of Hispanic descent. In addition, when money is remitted, the recipient must go to the bank to receive the proceeds, again a socially difficult action for the Hispanic community.

In yet another scenario, where the recipient already has an existing bank account, only the remitter's account needs to be opened. Where the remitter has an existing bank account, only the recipient's account needs to be opened.

Meantime, the B/CP at the remittance facility electronically transfers the funds to be remitted from the remitter's first bank account in the US to the recipient's second bank account.

Still another existing model system, generally represented by FIG. 2, and which can be used to transfer funds, is built on a payroll debit card system. Under such system, an employer pays the employee by giving the employee a debit card and PIN access number, and opening a bank account in the name of the employee and linking the bank account to the debit card. The employee's net payroll proceeds are deposited in the bank account, and are available to the employee either through conventional banking activities at a bank facility, or by use of the debit card and associated PIN access number at any POS and/or any ATM.

Such payroll debit card system may enable the employee to set up a second bank account in the US, in the name of a funds recipient in a second country and have the bank issue a second debit card in the name of the recipient and link the second debit card to the second bank account. The employee can then instruct the bank to transfer funds from the first bank account to the second bank account. Once the recipient in the second country, e.g. Mexico, receives the debit card, and associated second PIN access number, and net funds have arrived in the second bank account, the recipient can access the funds in the second account in the conventional manner such as by appearing in person at any branch facility of the bank, or can access the funds through any point of sale terminal (POS) which accepts the respective brand of debit card, or through any automatic teller machine (ATM) which accepts the respective brand of debit card. Each time a withdrawal is made, applicable transaction fees, if any, are charged to the account, along with corresponding currency conversion fees.

Throughout the teaching herein, any reference to use of a debit card at any electronic terminal such as POS or ATM is conditioned on that particular terminal being programmed to interact with the brand identity, e.g. VISA, Mastercard, Discover, etc, on the respective card.

While the methods and systems illustrated in FIG. 2 are available and are generally functional, and substantially less expensive than the system and method of FIG. 1, the system models and methods of FIG. 2 suffer from other obstacles which have prevented their widespread use.

A first problem with the bank system of FIG. 2 is that a branch office must be located near the recipient, which is often not the case.

A second problem is that especially persons of Hispanic descent have a cultural distrust of banks and so refuse to use banking facilities, even though the cost is less.

A first obstacle to widespread use of payroll debit card systems is that payroll debit cards are not universally available to the general public, availability being limited to those persons whose employers use payroll debit card systems to distribute payroll funds.

A second obstacle to widespread use of payroll debit card systems for international remittances is that the functionality of such systems for transmitting funds is not well known, and the employer has no direct business motivation to promote sale or use of remittance services.

A third obstacle is that the laws, rules, and regulations require that setting up the second account and issuing the second debit card include the employee going to a banking facility. As discussed above, Hispanic people generally do not voluntarily enter into banking relationships and do not enter bank facilities. Accordingly, payroll debit card systems, and debit cards in general, are not widely used as tools to remit funds to second countries.

In addition to the systems illustrated in FIGS. 1 and 2, certain retailers have established money remittance systems through their own corporate finance divisions, thus to send money from a first store in e.g. the US to a second store in the receiving country e.g. Mexico. While this system overcomes the cultural distrust of banks by by-passing the banking system, and the system is generally more cost effective than the model of FIG. 1, the retailers currently offering such services have only a limited number of stores outside the US and thus can serve only small portions of the geographies of many destination countries.

Given the problems, both physical and cultural, with the systems and methods illustrated in FIG. 2, the system and methods of FIG. 1 currently dominate the money remittance market, in spite of the high transaction costs associated with such system and methods.

The above discussion illustrates certain specific conventional systems which have been created to handle international funds remittances. An additional limitation of such systems is that such systems must comply with the requirements of various laws, regulations, and rules pertaining to the conventional banking community, and which laws, regulations, and rules are directed toward detecting unauthorized transfers of funds such as money laundering, transfer of funds by terrorists, and the like, across national boundaries. Of most concern are laws, regulations, and rules directed at the banking system.

The Western Union® model of FIG. 1 has relatively fewer restrictions because it operates outside the conventional banking system.

The bank model of FIG. 2, applied to bank-to-bank transfers, is controlled by all banking laws, regulations, and rules. Under those restrictions, and as indicated in FIG. 2, a maximum of only US$2000 can be deposited in the remittance account per month from cash, and subsequently transmitted to the recipient account. While there is no limit on the amount of direct payroll deposit monies which can be deposited in the account and subsequently remitted outside the country, the systems and methods of FIG. 2 are directed to the general consumer, not to the employer, and so generally do not contemplate payroll deposits. Accordingly, even where used, the systems of FIG. 2 are generally limited to remitting no more than US$2000 per month to a second (non-US) country.

A further limitation of the banking model illustrated in FIG. 2 is that both the remitter and the recipient must physically come to one of the bank facilities/buildings to initiate the respective first and second accounts. Such initial presence at the bank facility is exempted where the initial remittance account is a payroll deposit account, linked to a debit card.

### SUMMARY

Given that a large proportion of the remittances to second countries are enacted by first generation immigrants; given that first generation immigrants tend to work in relatively lower paid jobs, given that first generation immigrants tend to have lower levels of education, a desirable function of any financial activity which is directed to first generation immigrants is that the sponsoring organization, or a facilitating organization, provide some level of financial literacy training to users of such financial activity.

Accordingly, there is a need for systems and methods which provide services for remitting funds from the US to second countries which systems and methods satisfy various ones of the following parameters:

a. the system is cost effective,

b. the system does not require the remitter to enter a bank facility to open the account,

c. the system does not require the remitter to enter a bank facility to initiate a remittance,

d. the system does not require the recipient of the funds to enter a bank facility to open an account or to access the remitted funds,

e. the system has a large enough number of effective nodes, either banking facilities or electronic terminals, at the recipient end of the transaction so that the recipient of the funds can access the funds without travelling a long distance,

f. more than US$2000 per month can be remitted from deposit sources other than payroll deposits;

g. provide financial literacy training to users of such remittances services; and

h. the services can be purchased using non-banking facilities, while using conventional banking infrastructure to dispatch a remittance outside the remitter's country.

Respective systems and methods of the invention satisfy at least some, and in some cases all, of the above parameters, and are thus attractive to first generation immigrants who prefer to avoid as much banking connection as possible, while being cost competitive with all other systems which are conventionally available.

In a first family of embodiments, the invention comprehends a debit card system, comprising a non-financial-institution, non-employer, sponsor; an affinity group comprising at least first and second natural person remitters, affiliated with the sponsor by other than an employee-employer relationship; a card processor; financial institution accounts established for respective ones of the at least first and second natural person remitters, the accounts comprising, as to a such natural person remitter, a first remittance financial account at a first financial institution, associated with the respective natural person remitter, and a second recipient financial account at a second financial institution, associated with a second legal entity recipient; a debit card linked to the second account, and adapted to deliver, through the second financial account, remittances received from the first financial account; and a PIN access number associated with the debit card thereby to enable the second legal entity to gain electronic access to the second account by use of the debit card and the PIN access number in combination, and thereby to enable the second legal entity to gain electronic access to funds remitted from the first account.

In some embodiments, the sponsor is a government-recognized non-profit entity.

In some embodiments, the debit card system further comprises a second debit card, linked to the first financial account, and a second different PIN access number associated with the second debit card.

In some embodiments, the debit card system further comprises a financial literacy program offered by the sponsor to the at least first and second natural person remitters.

In some embodiments, the debit card is a bearer debit card, optionally an open loop debit card.

In some embodiments, the second legal entity is not the sponsor and is optionally a natural person.

In some embodiments, the debit card system further comprises a facilitating organization which facilitates gathering together a group of interested people for the sponsor, and wherein the facilitating organization is selected from the group consisting of government-recognized non-profit organizations such as social organizations, civic organizations, community organizations, spiritual organizations, and government-sponsored organizations; official government organizations; and for-profit business entities.

In some embodiments, the debit card system further comprises a tracking entity, adapted to receive tracking communications from the first financial institution, the tracking entity employing tracking software to identify and keep record of sources of funds transferred into the first financial account in addition to payroll and cash sources.

In some embodiments, the tracking software can distinguish the source of any funds deposited into the second account according to at least payroll, cash, or other financial accounts.

In some embodiments, the tracking software can distinguish, as to the other financial accounts, between checking accounts, savings accounts, and money market accounts.

In some embodiments, the debit card, in combination with the PIN access number, is effective to activate receipt of a remittance at one or more of a point of sale terminal and an automatic teller machine.

In some embodiments, both of the first and second financial accounts are associated with a single financial institution.

In some embodiments, rules associated with the second recipient account block such second recipient account from receiving funds from any source other than the first remittance account.

In some embodiments, the first debit card and the second debit card bear a common card brand identity.

In some embodiments, the first financial institution and the second financial institution are the same financial institution.

In a second family of embodiments, the invention comprehends a method of setting up an international monetary remittance system for a group of natural persons capable of benefitting, as a member group, from such remittance system. The method comprises publicizing features of the remittance system to a targeted audience of natural persons and thereby encouraging such persons to engage with a sponsoring non-profit organization so as to gain additional information about such remittance system; providing additional information to persons responding to such publicizing thereby to obtain purchase decisions from at least some such responding natural persons, thus to convert such responding persons into purchasing members; and closing sales to such responding natural persons by, as to a such responding person, setting up a first primary remittance financial account in the name of the responding person, as remitter, setting up a second recipient financial account at the request of the responding person, in the name of a second natural person, and without the presence of the second natural person, assigning a debit card to such second natural person, linking the debit card to the second recipient financial account, and assigning a PIN access number in association with the debit card thereby to enable electronic access to the second recipient financial account by using the debit card.

In some embodiments, the publicizing is done by a facilitating organization in a relationship other than an employee-employer relationship with the targeted group of natural persons.

In some embodiments, the facilitating organization receives payment for assisting in attracting persons of the targeted group into a relationship with the sponsoring organization.

In some embodiments, the non-profit sponsor provides financial literacy training for members.

In some embodiments, the debit card is effective to activate receipt of a remittance at one or more of a point of sale terminal or an automatic teller machine.

In some embodiments, the method further comprises linking the first financial account to tracking software which tracks the source of each deposit, and enables receiving deposits from cash, from payroll deposits, and from other existing and identifiable financial institution accounts.

In a third family of embodiments, the invention comprehends a method of transmitting a desired amount of money from a first location to a second different location. The method comprises depositing into a first financial remittance account, which is not a payroll deposit account, at the first location in a first country, enough money to support transmitting the desired amount of money from the first location to the second location; effecting electronic transfer of the desired amount of money to a second different financial recipient account in the first country; and using a debit card, in a second different country, withdrawing at least a portion of the transferred money from the second financial recipient account at the second location.

In some embodiments, the method comprises activating receipt of at least a portion of a remittance at one or more of a point of sale terminal in the second country or an automatic teller machine in the second country.

In some embodiments the method further comprises linking the first financial account to tracking software adapted to track the source of each deposit, and enabling the first financial account to receive deposits from cash, from payroll deposits, and from other existing and identifiable financial institution accounts, and tracking each deposit into the first financial remittance account, according to cash, or payroll deposit, or other existing and identifiable financial institution accounts.

In a fourth family of embodiments, the invention comprehends a method of marketing an international monetary remittance system. The method comprises identifying one or more target groups, wherein individual persons in a given such target group share a common interest, pertaining to making international money remittances from a first remitter person in a first country to at least a second receiving entity in a second country; setting up at least first and second community events, spaced from each other in at least one of space and time, wherein the locations are not at physical locations occupied by financial institution facilities, and wherein the events encourage attendees of such events to make purchases of services which activate accounts and systems capable of effecting international monetary remittances from a first country to a second country, wherein debit cards are used to receive such remittances; marketing the at least first and second community events to the identified one or more targeted groups and thus drawing responsive members of such target groups to at least one of such at least first and second community events; conducting the first community event at a first time and at a first location, including collecting a first set of information, and payments for services, from a first group of purchasers who attended such community event, and activating a first set of financial accounts and debit cards for such first group of purchasers, based on the first set of information so collected, and conducting the second community event at a second time and/or a second location, including collecting a second set of information, and payments for services, from a second group of purchasers who attended such second community event, and activating a second set of financial accounts and debit cards from such second group of purchasers, based on the second set of information so collected.

In some embodiments, the financial accounts, as to a given purchaser comprise a first remittance account associated with the purchaser and a second recipient account associated with a second entity named by the purchaser.

In some embodiments, both of the first and second accounts are associated with a single financial institution.

In some embodiments, the method further comprises assigning a debit card, and associated PIN access number to the second recipient account.

In some embodiments, the method comprises activating first and second such debit cards linked to the respective first and second financial accounts, and wherein the first debit card and the second debit card bear a common card brand identity.

In a fifth family of embodiments, the invention comprehends a method of marketing an international monetary remittance system. The method comprises identifying one or more target groups, wherein individual persons in a given such target group share a common interest, pertaining to making international monetary remittances from a first remitter person in a first country to at least a second receiving entity in a second country, and wherein individual persons in such target group have existing trusted group-related relationships with a non-employer, government-recognized, facilitating entity which already interacts with persons in such target group; and marketing international remittance services to such target group through one or more such trusted facilitating entity such that individual persons in such target group are encouraged by such one or more trusted facilitating entity to purchase such international remittance services either directly from such trusted facilitating entity or from a sponsoring at a venue where such trusted entity has at least a temporary presence.

In some embodiments, the trusted entity is a religious organization.

In some embodiments, the trusted entity is a for-profit non-financial business, and is not a debit-card processor.

In some embodiments, the method further comprises, as to a given such individual purchaser, setting up a first financial remittance account associated with the purchaser, and setting up a second financial recipient account associated with a second different legal entity, and linking a debit card and associated PIN access number with the second financial recipient account.

In a sixth family of embodiments, the invention comprehends a method by which a processor of unfinished goods, who purchases such unfinished goods from a group of producers of such unfinished goods, pays individual producers of such unfinished goods for purchases of such unfinished goods. The method comprises setting up a first primary remittance financial account representing the processor of the unfinished goods; setting up multiple recipient financial accounts including at least one recipient financial account representing each producer of unfinished goods; assigning debit cards to the producers of unfinished goods and linking the debit cards to the recipient financial accounts; assigning PIN access numbers associated with the debit cards thereby to enable electronic access to the funds in the recipient financial accounts; receiving and purchasing unfinished goods from a producer of unfinished goods; and paying for the purchase of the unfinished goods by transferring an appropriate quantity of funds from the first primary remittance account to the recipient account representing the respective producer of unfinished goods, whereby the respective producer of unfinished goods can access and use the funds so transferred by using the respective debit card and assigned PIN access number.

In some embodiments, the goods are unfinished agricultural goods.

In some embodiments, the debit cards are open loop debit cards.

In some embodiments, the method further comprises the processor of goods selling the debit cards to the producers of unfinished goods.

In some embodiments, the method initially protects the producer of unfinished goods from theft of cash money, and enables the producer of unfinished goods to pay bills, to purchase goods and services, without handling any cash, as well as to access cash.

In some embodiments, rules associated with a such recipient account block the respective recipient account from receiving funds from any source other than such processor of unfinished goods.

### BRIEF DESCRIPTION OF THE DRAWINGS

FIG. 1 shows a flow chart of a private-company remittance model which uses non-banking facilities to sell the service, and which generally uses non-banking facilities to effect remittances, though the private company can use conventional banking infrastructure to balance cash flows within the company and/or to effect certain actions required to transact a remittance.

FIG. 2 shows a flow chart of a remittance model which uses conventional banking facilities to sell the service, and conventional banking system infrastructure to effect remittances.

FIG. 3 shows a flow chart of a remittance model of the invention, which uses non-banking facilities to sell the service, and conventional banking system infrastructure to effect remittances.

FIG. 4 shows a flow chart of a remittance model of the invention, which uses non-banking facilities to set up a remittance system whereby a processor of unfinished goods pays producers of unfinished goods for the goods so produced.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

The world wide remittance system of the invention uses specially-programmed and enabled debit cards to avoid most of the limitations imposed on conventional wire, or conventional retail card based systems. Found in US Federal Banking Regulations and the US Patriot Act, such limitations are designed to detect and combat money laundering and terrorism. Unfortunately, they also impede certain legitimate uses of conventional debit card accounts to send money from the United States to another country, e.g. Mexico, Guatemala or El Salvador, whereby debit card accounts, though potentially more cost effective, so far have not become the preferred method to transmit such remittances.

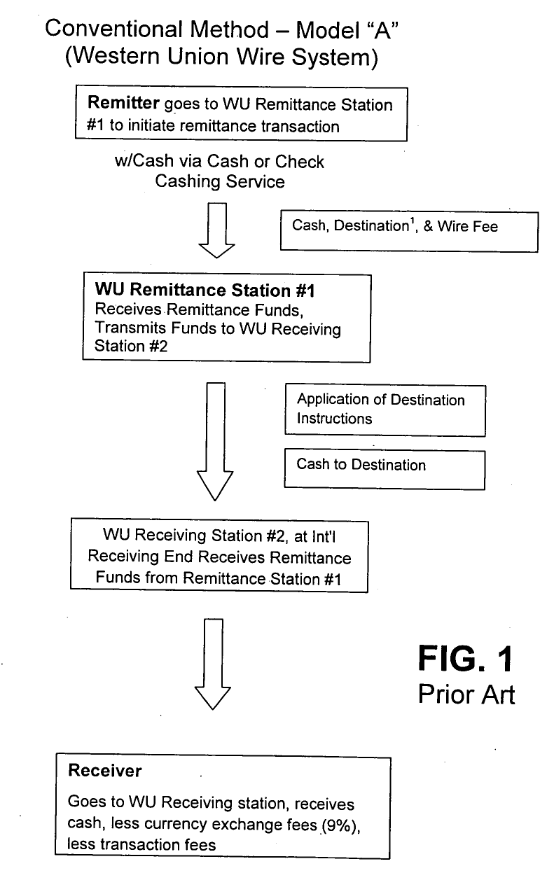

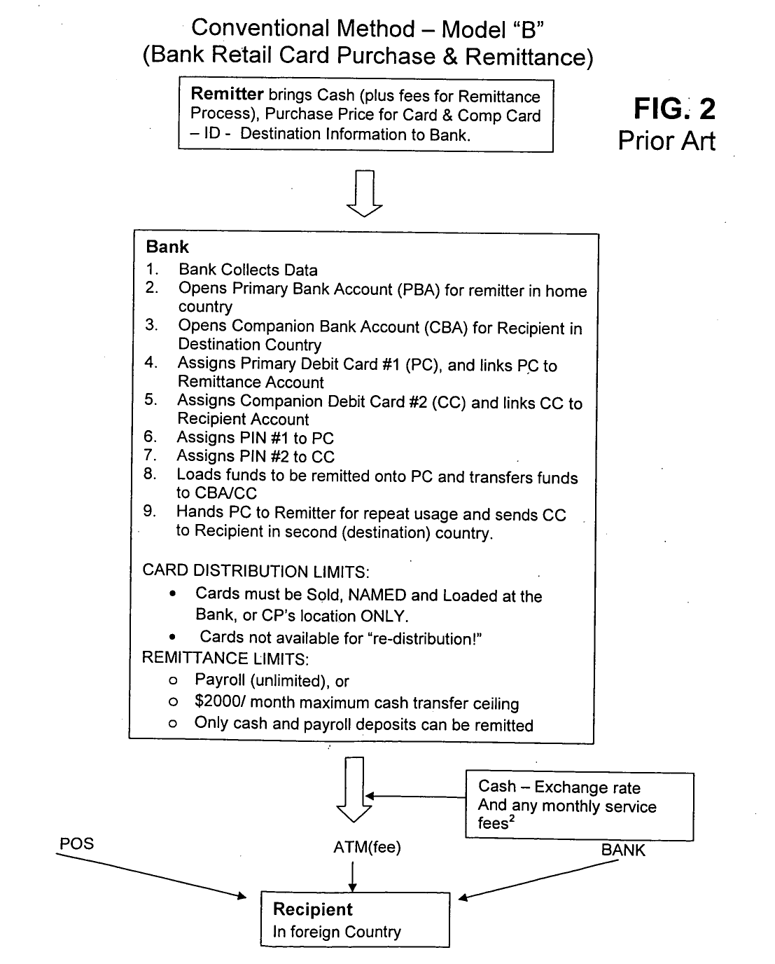

All of the US Government regulations relating to remittances address primarily one issue, that being the transparency of the transaction. Restated, they address the concern of being able to discern the source of the funds which are being transmitted. Whether conventional private wire transfers such as illustrated in FIG. 1, bank-to-bank transfers as illustrated in FIG. 2, conventional card systems purchased by individuals at retail, or payroll debit card accounts, are used to send/remit funds, Federal regulations limit their use.

By law, regulation and/or rule, such transfers/remittances can come from only two sources of deposit: payroll (unlimited deposits and transfers) and cash (remit out of the US no more than US$2000 cash/month).

With the exception of payroll debit cards, Federal regulations also require that the user enter a business establishment of the Remittance Processor (RP), such as Western Union® or a bank, and interact with a live agent of the Remittance Processor. Whether using private-company wire service such as Western Union®, or using a retail debit card system other than a payroll debit card, the remitter must always initiate the transaction at the business establishment location of the Remittance Processor.

In conventional practice, the remitter must also interact with a live agent of the remittance processor. This requirement for interaction with a live person drives much of the expense related to traditional wire transfer systems, and the requirement to enter the business establishment of the remittance processor clashes with cultural distrust of the banking system, thus driving broad cultural impediments to using debit cards to make such remittances.

In light of the above requirements imposed on the remitter, infrastructure available for completing the transaction consequently forces the receiver to use correspondingly similar and limited points of receipt.

And while payroll debit cards can satisfy some of the technical and cultural shortcomings of the above systems, payroll debit cards are not widely available to the general public.

The card systems of the invention, and methods of using the systems of the invention, effectively address the above impediments by building on sections of the laws, regulations, and rules which provide for preferred treatment for certain types of deposits. Namely, preferred treatment is accorded deposits where the sources of the deposits can be verified by a government-recognized third-party tracking entity. The laws and regulations also provide preferred treatment where a government-recognized third party sponsoring organization has at least some interaction with the remitter in setting up the account, and wherein the third party government-recognized tracking entity tracks and identifies the sources of all deposits into the account, such that the sponsoring organization and the tracking entity together serve as quasi-legitimatizing entities regarding the relationship of the remitter with the account and the sources of the funds.

In actual conventional practice, the only use of such preferred treatment has been limited to the employer-remitter relationship. However, the inventors herein, having discovered that the laws, regulations, and rules are not so limited, have developed remittance systems which use a non-profit organization, organized under what is known in the art as section 501(c)(3) of the Internal Revenue Service code, as the sponsoring organization, and a private company known as Virtual Automation Technologies, Portland Oreg. (VAT), as the tracking entity which tracks all deposits into the respective remittance accounts and identifies the sources of all such deposits, using what VAT calls its “Flexible Recognition” tracking software.

The logic of such preferential treatment is that the funding end of the transaction is relatively transparent. Namely, the remitter must still show up somewhere in a face-to-face meeting with a government-recognized organization, but not necessarily a bank, to set up the accounts, and a third party tracking entity, namely VAT or a similarly-capable and qualified organization, verifies the source of every deposit into the remittance account; similar to the participation of the employer, as sponsor of the remitting account, and the employer as the source of deposits in an employer-sponsored account.

Where the employer is both the sponsor and the depositor of payroll funds, the remitter is still limited to remitting no more than US$2000 per month from cash deposits whereas, with systems of the invention, the laws, regulations, and rules permit up to 10 remittances per month from cash deposits, each such remittance being up to US$950, for a total allowance of up to US$9500 per month remittances sourced from non-payroll deposits, plus capability to remit, in addition, any amount from payroll deposits made during that same month. In addition, non-payroll deposits can be made and remitted in unlimited amounts from checking accounts, savings accounts, money market accounts, loan proceeds, and any other traceable sources. Thus, having two third-party organizations in the system actuates even more flexibility in the laws, regulations, and rules, as relates to the remittance account holder, than a conventional payroll debit card system.

Whether payroll debit card systems and methods, or systems and methods of the invention, the processes have record-keeping and/or reporting requirements which provide relatively visible mechanisms through which the sources of funds can be traced. Because of such relative visibility, remittance transactions from such accounts, to recipients outside the US, are less heavily regulated.

In practice, debit cards of the invention are delivered as part of the membership benefits which attach when a natural person, namely a potential future remitter, joins a Financial Literacy or other beneficial program sponsored by an established 501(c)(3) non-profit organization, or becomes a member a sponsoring 501(c)(3) which offers such beneficial program. For purposes of the existing regulatory environment, the 501(c)(3) non-profit organization, to some extent, takes the place of the employer in a payroll debit card system in providing part of the transparency and legitimacy the regulations seek. In the same way, an employer can purchase and distribute bearer, open-loop payroll debit cards, and link the debit cards to bank accounts, the sponsoring non-profit organization can purchase and distribute bearer, open-loop debit cards and can subsequently re-distribute/sell the cards to its members and link the debit cards to bank accounts in the conventional banking infrastructure.

As with conventional retailed debit cards routinely issued by banks, a debit card of the invention displays a card number. Unlike retailed debit cards, debit cards of the invention do not display any visible indication of the identity of the card owner. Accordingly, such cards, to the extent permitted by law, can be bought and sole multiple times and can thus be distributed through a multiple-level distribution system.

For purposes of tracking deposits into the remittance account, and identifying sources of such deposits, the VAT Flexible Recognition tracking software query and recognition features are linked to the identities, namely card numbers, of debit cards of the invention. Accordingly, the VAT Flexible Recognition tracking software queries and records all remittances into the account, thus keeping track of the sources of all deposits into the remittance account, thus providing an additional increment of the transparency and legitimacy which the laws, regulations, and rules seek.

Applicants' sale/resale process through the government-recognized non-profit organization, using debit card systems of the invention, provides a number of benefits.

For example, since the cards are sold outside the conventional banking system, sale of the cards is not subject to banking regulations, which allows the card provider to offer card features which are more attractive to potential card purchasers. For example, card systems of the invention can offer:
(i) “Immediate access” cards which do not require naming of the card owner until the card reaches the end user.
(ii) Since card sales are not subject to banking regulations, the laws, regulations, and rules do not prohibit sale of the cards in a more casual market setting, namely outside and away from any banking institution facility.
(iii) The cards, themselves, need not display any visible representation of the name or other identity of the named owner of the card. In light of these features, immediate access cards can, in effect, be re-sold through all levels of a multiple-level distribution system, whereby the sales setting can be structured according to its attractiveness to potential purchasers of such card services, rather than being dictated by banking regulations.
(iv) Expanded flexibility attaches to use of card systems of the invention in that the card systems can accept a wider variety of funding sources which provide funds which can subsequently be remitted outside the US, and which can be used to remit greater amounts of money in a given period of time using non-payroll sources of funds, while maintaining the capability to remit unlimited amounts of money sourced from payroll funds.
(v) Card systems of the invention do not have the expense of private company remittances, do not require interaction with any natural person to remit funds outside US boundaries, or to receive funds outside the US, and do not have the cultural impediments which attach to overt use of banking facilities, while using conventional international financial/banking infrastructure to move remittances out of the US and to receive the remittances in the second country. Namely, use of the conventional banking system infrastructure, in systems and methods of the invention, can be largely invisible to the remitter/user, if the remitter/user elects to use an ATM, a phone contact, or a web site, to instruct the remittance. Use of the conventional banking system infrastructure can be largely invisible to the receiver/user if the receiver/user elects to use ATM or POS facilities to receive and/or use the funds.
(vi) While operators of card systems of the invention can set up multiple non-profit organizations to deal with, do business with, maintain working relationships with, multiple employers and other recognized organizations, a card system operator can create a single qualifying and sponsoring 501(c)(3) non-profit organization which can distribute, assign and load cards both to individuals directly and through facilitating organizations, including through multiple levels of a distribution system, wherever the card system operator's non-profit organization is invited, or otherwise permitted, to present and offer the card system, such as to a group of prospective purchasers of such service at an event sponsored by a facilitating organization. Thus, given that the card system operator owns and controls the sponsoring 501(c)(3) non-profit organization, the card system operator can offer the card system to any group of one or more prospects, through any facilitator or facilitating group or other facilitating organization.

In general, an effective way of marketing card systems of the invention is to partner with existing organizations, as facilitating organizations, which have existing members and/or member prospects, or target markets to which such card systems and services are expected to be attractive. For example, the sponsoring non-profit organization can work with businesses, churches, community centers & programs, as facilitating organizations, any of whom may have lists of people with whom they affiliate, or wish to affiliate, who may have a common interest in a remittance system which facilitates sending money outside the country. For example, especially first-generation immigrants commonly wish to send money to family members or friends e.g. in their native country, but require that the recipient have access to only the specified amount of money. By offering cost effective and culturally sensitive systems and methods for making such remittances, such facilitating organization can attract new members, thus benefitting the entire membership with greater efficiencies related to size of the facilitating organization.

Such offering can be made at a specially-organized event at the facilities of the respective e.g. facilitating business, church, or community center; or a meeting can be held at a park or other public meeting place, and still remain in full compliance with all applicable laws, regulations, and rules related to distribution of such debit cards.

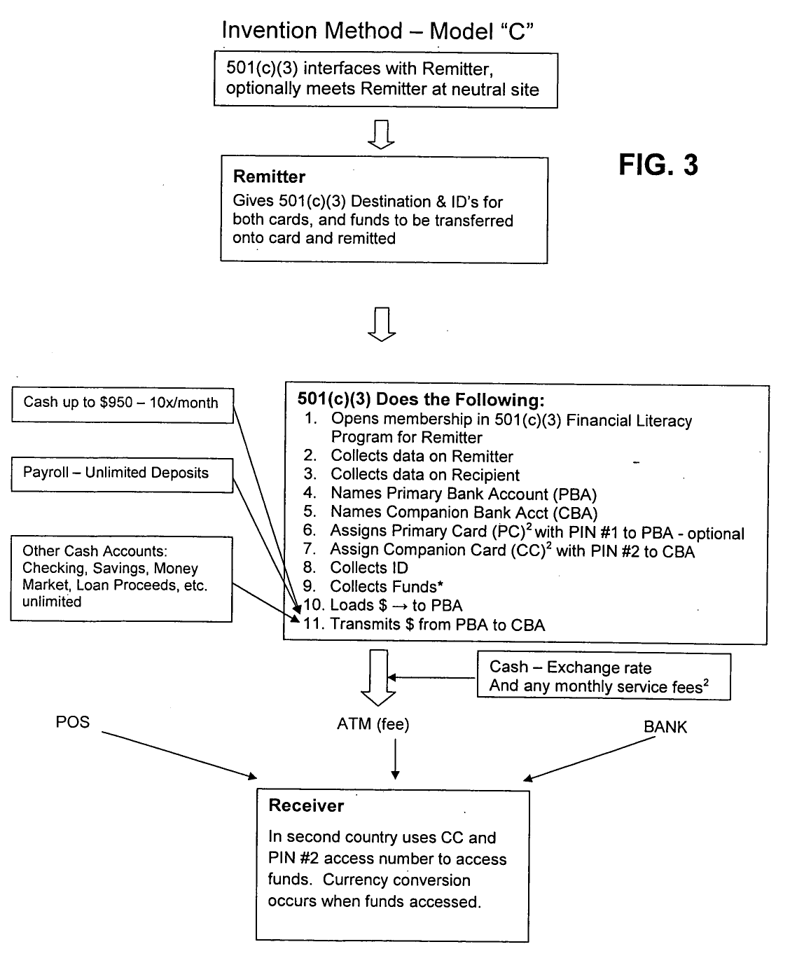

Turning now to FIG. 3, a card operator sets up a non-profit organization which acts as a non-financial sponsoring institution entity, namely a 501(c)(3) organization. The sponsoring non-profit organization has a non-profit function of providing a financial literacy education program to its members. While financial literacy is a special concern for first first-generation immigrants, a much wider scope of society can benefit from various financial literacy information, whereby membership in the non-profit organization need not be limited to only first-generation immigrants. Accordingly, membership in the non-profit organization is open to all members of the general public.

As a membership benefit, the sponsoring non-profit organization, as set up by the card operator, also offers remittance accounts which enable the member to easily and cost-effectively send remittances outside the US, such as to a friend or relative in his/her native country. Such accounts are sold outside conventional banking facilities, and are set up to interact with conventional banking infrastructure in transacting remittances from the US to second countries. As desired, of course, remittances can be transacted in the opposite direction, namely from a remitter in a second country to a recipient in the US.

Because the sponsoring non-profit organization is not a financial institution per se, the non-profit organization is not subject to the same banking laws, rules, and regulations which apply to banks and other financial institutions. As a result, the non-profit organization can sell its memberships, as well as its remittance accounts, at locations not situated at facilities of any financial institution, whereas a financial institution is required to limit the transaction of its business with customers to locations where it has physical facilities. Thus, a bank cannot sell bank services, or open an account, at e.g. a church, a park, a school, or other non-financial facility. But a non-profit organization is allowed under the laws, regulations, and rules to connect to the banking system from any location, to set up an account for a member, or to transact business on behalf of its member at any location, whether inside a banking facility or not inside a banking facility.

Thus a card operator, through its sponsoring non-profit organization, can set up business anywhere, either permanently or temporarily, physically or virtually, and promote its membership and all of its services, including its remittance accounts. In addition, the card operator can engage e.g. for-profit merchants to promote and sell its memberships, including the benefits of its remittance accounts which are part of the membership services/benefits. Thus, the non-profit organization can sell memberships through an ethnic food store, through an ethnic restaurant, or through any other for-profit, or not-for-profit, organization other business which interacts with the target market.

The card operator, through its non-profit organization, can also engage the assistance of other non-profit organizations in gathering together potential members, and explaining the sponsoring non-profit organization's benefits to its membership. For example, the card operator, through the sponsoring organization, can engage the leadership of a church which serves a Hispanic community, or which wishes to serve the Hispanic community, to promote an event, such as a day-long gathering, where attendees can learn about the church, can learn about the sponsoring non-profit organization, and about the remittance services which are available from the sponsoring non-profit organization. At such event, both the church and the non-profit organization gain market exposure to their target market.

At such event, the church, as the facilitating organization, can promote its benefits, and the sponsoring non-profit organization can promote its benefits, including the remittance service, and can sign up members, including opening the appropriate bank accounts which are needed to interface between the remitter and the conventional banking infrastructure in order to effect transactions between the new member/remitter and a recipient, using a debit card to withdraw, receive, use, or otherwise to retrieve the transferred funds at the recipient end of the transaction.

As illustrated in FIG. 3, the sponsoring non-profit organization explains, typically to a group of interested attendees, the benefits of its membership, including the financial literacy training, and its remittance accounts. Interested attendees are directed to meet individually with representatives of the sponsoring non-profit organization to set up their memberships and open remittance accounts.

When an interested natural person meets with a representative of the non-profit organization as a potential member, the interested person/potential member supplies the non-profit representative with his/her own identification, as well as the identification of the recipient person or persons who are to receive remitted funds e.g. in a second country, and the location where that recipient person or those recipient persons can be reached, along with any necessary contact information for both the potential member and the recipient of such remitted funds.

The non-profit representative takes the following actions:
1. collects identification information, and contact information, from the interested natural person who is to be a new member of the non-profit organization,
2. opens membership in the non-profit organization for the new member, including inclusion in the financial literacy program,
3. records all appropriate data pertaining to the new member/remitter and the recipient,
4. names a Primary Bank Account (PBA) in the name of the new remitter/member,
5. names a Companion Bank Account (CBA) in the name of the recipient,
6. takes from inventory a first, Primary Debit Card (PC), which bears a first card number, and assigns the Primary Card number and first PIN to the remitter,
7. links the PC to the PBA,
8. takes from inventory a second, Companion Debit Card (CC), which bears a second different card number, and assigns the Companion Card number and second PIN to the recipient,
9. links the CC to the CBA,
10. collects funds from the new member for setting up the accounts and cards, and loading an initial deposit into the remittance account,
11. loads the initial deposit into the remittance account,
12. transfers from the PBA to the CBA any funds which the new member wants to send as an initial remittance, if any, at that time,
13. gives the new member the Primary Card,
14. sends the Companion Card to the recipient,
15. sets up additional accounts and additional cards for second and further recipients, if any, of such remittances, and sends the additional cards to the recipients, and
16. provides the new member with an information packet giving detailed instructions in the appropriate language for use of the remittance system, including use of the debit card system to load remittance amounts on the debit card, whereafter the remittance amounts can be accessed by the recipient from the designated recipient account.

As set up above, the remittance account in the name of the member is a first account, and the recipient account in the name of the recipient is a second different account. The first and second accounts are related only in that they were both set up to accomplish a single purpose, namely to facilitate transfer of money from the remitter in a first country to the recipient in a second different country. Both accounts can be associated with a single bank, both in the US. Or the two accounts can be set up at two related or unrelated banks, both in the US. Or the two accounts can be set up at two related or unrelated banks, one of which is in the US and the other of which is in the destination country to which the funds are to be transferred. Or the two accounts can be set up at one or more related or unrelated banks outside the US, optionally in the destination country.

As will become clear hereinafter, the first debit card, issued to the remitter/member is optional, and remittances can be transacted without any use of the first debit card—although use of the first debit card can facilitate the remittance transactions.

Because two accounts are set up, because the recipient has access only to the Companion Bank Account, the recipient cannot access any of the funds in the Primary Bank Account. Only when funds are transferred from the Primary Bank Account to the Companion Bank Account does the recipient have access to the transferred funds. Accordingly, the remitter is not at risk of having the recipient take more funds than planned by the remitter. Likewise, once the funds are transferred from the PBA to the CBA, the remitter loses control of the transferred funds, and the recipient gains full control of those funds.

Because the remittance service, and the respective bank accounts and debit cards are initiated outside the banking system, the Companion Bank Account and the Companion Card can be sold to the remitter without the recipient being present, or having to sign any documentation. Accordingly, even though the recipient is in a distant location outside the remitter's country, the accounts can still be easily set up and tied to the remittance system being sponsored by the non-profit organization. The remittance service, and the respective bank accounts and debit cards can be initiated outside the banking system because the non-profit organization is a government-recognized legitimizing organization exempt from corresponding ones of the banking laws, regulations, and rules.

Once the PBA has been funded with sufficient money, the remitter can transfer a desired amount of money from the PBA to the CBA (called loading the card), up to the limits allowed by the applicable laws, regulations, and rules. The amount of money which can be sent in any given month depends on the transparency of the sources of deposits into the remittance account. Where no special transparency is provided, such as in a general purpose debit card account, remittances are limited to no more than the amount of payroll direct deposits plus $2000 per month. Where additional transparency is provided regarding deposit sources, such as VAT's Flexible Recognition tracking software, up to $9500 per month can be remitted from other than payroll deposit sources.

Since VAT is a debit card programmer, VAT can write whatever program is desired for use of the card, and any transaction involving the card, or its linked bank account, is automatically communicated to VAT for software implementation. In setting up a debit card for Flexible Recognition implementation, VAT links the debit card identity with the Flexible Recognition tracking software, such that the debit card number is already linked to the Flexible Recognition tracking software before the card is released for distribution to a customer. When the debit card is set up for a user, the debit card number is linked to the corresponding bank account, whereupon the bank account number is inherently linked, through the debit card number, to the VAT Flexible Recognition tracking software.

Any time a transaction is initiated in that linked bank account, as part of the transaction, the transaction information is communicated to the Flexible Recognition tracking software at VAT. The Flexible Recognition software can distinguish between deposits and withdrawals, including remittance withdrawals, including withdrawals which are transfers to the recipient bank account which has an owner who does not reside in the US. Namely, the Flexible Recognition tracking software recognizes at least the recipient's destination account when a remittance is made to that account.

In addition, the Flexible Recognition distinguishes certain sources of deposits. Thus, the Flexible Recognition tracking software separately distinguishes (i) cash deposits and (ii) non-cash deposits. In addition to electronic payroll deposits, the non-cash deposits can be sourced from, for example, checking accounts, savings accounts, money market accounts, loan proceeds, and other traceable sources.

Given the ability of the Flexible Recognition tracking software to recognize such other sources of deposits, as long as the source of the funds can be identified and recorded by the software as being other than cash, the laws, regulations, and rules place no limitations on the amounts of such deposits which can be remitted outside the US to and/or through the CBA. Further, given the transparency provided by the Flexible Recognition tracking software, and the legitimacy of the remitter provided by the sponsoring 501(c)(3) organization, the cash remittance limits are increased by the laws, regulations, and rules, to 10 remittances per month, up to US$950 each, for a monthly cash remittance amount of up to US$9500 per month.

When a deposit is received in such linked bank account, the deposit information is communicated to VAT, to the Flexible Recognition tracking software. The Flexible Recognition software obtains and records identifying information regarding the source of the deposit. Thus, if the deposit is a cash deposit, the Flexible Recognition tracking software records the deposit as a cash deposit. If the deposit comes from a savings account, the Flexible Recognition tracking software records the source as the respective savings account. If the deposit comes from a checking account, from loan proceeds, from a money market account, the Flexible Recognition tracking software thus “flexibly” recognizes the specific nature of the deposit source, as well as any account number and/or financial institution associated with the deposit source. Namely, once the funds are in the financial system and associated with an account and a financial institution in the system, the Flexible Recognition tracking software can identify the source of the funds at the time the funds are deposited, transferred into the PBA.

When the remitter requests a transfer of funds to the CBA, the request is communicated to the Flexible Recognition tracking software at VAT. Upon receipt of the request, the Flexible Recognition tracking software then queries its recorded data regarding deposit sources and screens the requested transfer amount against its record of qualifying deposits. If the amount of the requested remittance is not greater than the amount of qualifying deposits, the requested remittance is approved, and communicated to the requesting banking, whereupon the banking institution released the remittance amount, transfers the remittance amount to the CBA, and confirms the remittance to VAT, where the remittance amount is recorded by the Flexible Recognition tracking software.

The debit cards, themselves which are used in the invention, are conventional “bearer, open-loop” debit cards. What provides the cards, and the card systems with special novelty is the sponsoring 501(c)(3) organization through which the debit cards are distributed. The sponsorship of the 501(c)(3) organization enables the cards to be distributed through other than regular banking facilities, thereby facilitating the distribution of the cards to the Hispanic market in culturally acceptable venues. Such cards can theoretically be distributed and linked to conventional card-processing software, which cannot recognize deposit sources other than payroll and cash, whereupon cash remittances are limited to $2000 per month, and only cash deposits and payroll deposits are eligible for international remittances.

An additional level of flexibility is conferred upon the remittance system by those embodiments of the invention which link the debit cards to a software program which can recognize additional sources of deposits, whereupon the remittance limits imposed by laws, regulations and/or rules are substantially raised.

Thus, in some embodiments of the invention, the debit cards, and thus the PBA, are associated with the Flexible Recognition tracking software, and in other embodiments of the invention, the debit cards, and thus the respective PBA, are not associated with the Flexible Recognition tracking software.

Now that the primary steps performed by the Flexible Recognition tracking software, and the purposes behind such primary steps, have been described, those skilled in the art of writing debit card software can write other software programs which perform the respective functions such that the software operates within the laws, regulations, and rules so as to provide remittance transaction capabilities the same as have been described for debit card systems of the invention, namely up to 10 remittances per month of up to $950 each, unlimited payroll deposit remittances, and unlimited remittances from other fund sources where deposits are transferred into the PBA from accounts at such other fund sources, all within the banking system; namely any deposit from within the banking system where the funding account can be identified as an account at a financial institution within the banking system.

In order for the recipient to access the transferred money, the recipient must first receive the debit card which is linked to the Companion Bank Account. Once the recipient has received the Companion Card, and the respective PIN access number, the recipient has full access to all funds in the CBA, including all funds remitted to the CBA from the PBA. The recipient can access the funds through a conventional visit to a respective bank which works with the respective card brand. For example, where the recipient debit card is a Discover® Card, the recipient can access the funds through any bank branch which recognizes and does business with the Discover® Card network.

Another way the recipient can access the funds is to simply use the debit card at any point of service terminal, such as a store, where the e.g. Discover® Card is accepted as payment for goods and/or services. Yet another way the recipient can access the funds is to withdraw the funds as cash at an Automated Teller Machine (ATM). A big advantage of the debit card system is thus that the recipient can access the funds without entering a conventional “brick and mortar” bank facility, thus overcoming the Hispanic cultural aversion to use of the conventional banking system. While the recipient is in fact using the conventional banking system, he/she does not need to be present in any recognized banking facility in order to do that, whereby the Hispanic cultural aversion to the banking system is avoided.

In the course of the remittance process, the currency is converted from the US dollar to the currency of the destination country at the time the money leaves the US. Accordingly, where the recipient bank account is in the US, the money stays in the US until the recipient makes a withdrawal, whereupon the conversion is made at that time, and any e.g. ATM associated with the transaction provides a print-out to the recipient showing the amount of US dollars converted, and the amount of money received by the recipient in the local currency.

Once the accounts are set up and the recipient has received his/her debit card, a remittance can be made at any time, so long as the limits on how much money can be transferred in a given month have not been exceeded. When the member/remitter desires to make a remittance, he/she instructs the bank having the Primary Bank Account to transfer a specified amount of money from the PBA to the CBA. The remitter can give such instruction by telephoning a bank service number identifying himself/herself to the bank service center representative using pre-assigned security code. Once identity has been confirmed and accepted, the remitter can then instruct the bank service representative regarding the desired transaction. The bank service representative makes the requested funds transfer to the CBA, whereafter the recipient can withdraw the funds from the CBA at any time.

Another way the remitter can instruct a remittance is through the internet. The remitter goes to a designated secure internet web site, enters required password and/or pass code or other security information for authentication purposes, and then provides the instructions regarding the recipient and the amount to be remitted. In any event, once the appropriate instructions have been given, the recipient can, shortly thereafter, access the funds in the Companion Bank Account.

In some embodiments, both the PBA and the CBA are accounts at the same bank, whereupon the transfer of funds from the PBA to the CBA is a fully transparent transaction, thereby facilitating clearance through any potential scrutiny of the transaction pertaining to banking laws, regulations, or rules, and reducing the probability that any such transfer, remittance will be questioned by any regulatory monitoring of transactions. For example, both accounts may be at Wells Fargo® Bank, whereby any such transfer of remittance funds is totally internal to the Wells Fargo® Bank organization. Similarly, if both debit cards bear the same brand name, e.g. both cards are Discover® cards, any card-to-card transaction takes place totally within the Discover® Card system.

Given the validation and legitimatizing authority conferred on the 501(c)(3) by the applicable laws, regulations, and rules, the sponsoring non-profit organization is not limited in the choice of time or location or means by which it exposes the benefits of its membership and/or its remittance system to the general public. Accordingly, the 501(c)(3) can publicize its offerings through any legitimate marketing and/or sales venue, including for example and without limitation marketing and sales through other facilitating organizations such as churches, schools, social fraternities, non-profit foundations, partnerships, and business organizations; marketing and sales through specialty stores which market and sell only the 501(c)(3) services; marketing and sales through direct mail; marketing and sales through the internet; marketing and sales through multiple level sales organizations; marketing and advertising through conventional media outlets such as radio, television, newspaper and magazines; and sales through brick and mortar retail businesses which also distribute other products and/or services.

The presence of representatives and/or other representation of the 501(c)(3) non-profit organization at the marketing and/or sales venue can be permanent or temporary. Where sales are made by other than the 501(c)(3) personnel, or through a virtual venue such as the internet, the function of the entity which receives the information and funds is to act on behalf of the 501(c)(3) organization in receiving the information and distributing the debit card to the remitter/new member, and to transmit the collected information to the 501(c)(3) organization, whereupon the 501(c)(3) activates the membership, activates the bank accounts, links the debit cards to the respective bank accounts, and sends the companion debit card to the recipient user of the companion bank account.

In light of the above, the information collected when an interested person signs up as a new member of the 501(c)(3) can be entered into banking system in real time through the internet, or can be recorded manually or otherwise and entered into the banking system at a later e.g. more convenient, time. Where the information is entered into the banking system at a later time, the bank account numbers, and optionally the debit cards, can be sent to the new member once all of the the banking information has been entered into the banking system.

In any event, according to conventional protocol, the PIN numbers associated with the debit cards are sent to the new member and the recipient user separately from any giving or sending of the debit cards to the remitter/member or the recipient user.

The debit card system of the invention has been described herein in terms marketing and selling the services in the US, and use of the services to send/remit funds out of the US. Once the system is set up, the system can as well be used to send money/funds the reverse direction, namely from the CBA to the PBA, whereupon the owner of the CBA becomes the remitter and the owner of the PBA becomes the recipient. Either direction, the same transaction activities take place.

The set-up of the bank accounts, and linking the debit cards to the bank accounts, has been described as taking place in the US. Such set-up can as well be done in the second (non-US) country, whereupon the bank accounts are typically set up in the second country, not in the US. Indeed, the bank accounts can be set up in a third country, not the US, not the destination country. Wherever the bank accounts are set up, the same transaction activities take place in remitting funds from the one of the account owners in one country to the other of the account owners in the other country.

In the methods of the invention by which a processor of unfinished goods pays for purchases of such unfinished goods from a group of producers of such unfinished goods, the steps taken by the processor/remitter in remitting funds to the recipient producers of goods are the same as the steps taken by the remitter in remitting funds to a recipient e.g. friend/relative outside the remitter's country. The only difference is that the recipient producers are in the same country as the processor of the unfinished goods. Further, in the process of setting up the respective accounts, as in the case of foreign country remittances, the processor/remitter sets up both the remittance account and the recipient accounts. Also similarly, both accounts can reside in the same country, and typically both remittance and recipient accounts will be established at a single financial institution/bank. Also as with the country-to-country remittance system of FIG. 3, the remitter optionally can have/use a debit card to transfer funds to the recipient accounts, but use of a debit card to make such transfers is optional for the remitter. Further, as with the country-to-country remittance system of FIG. 3, the recipient typically accesses the funds by using a debit card at a local bank, at an ATM, or at a POS.

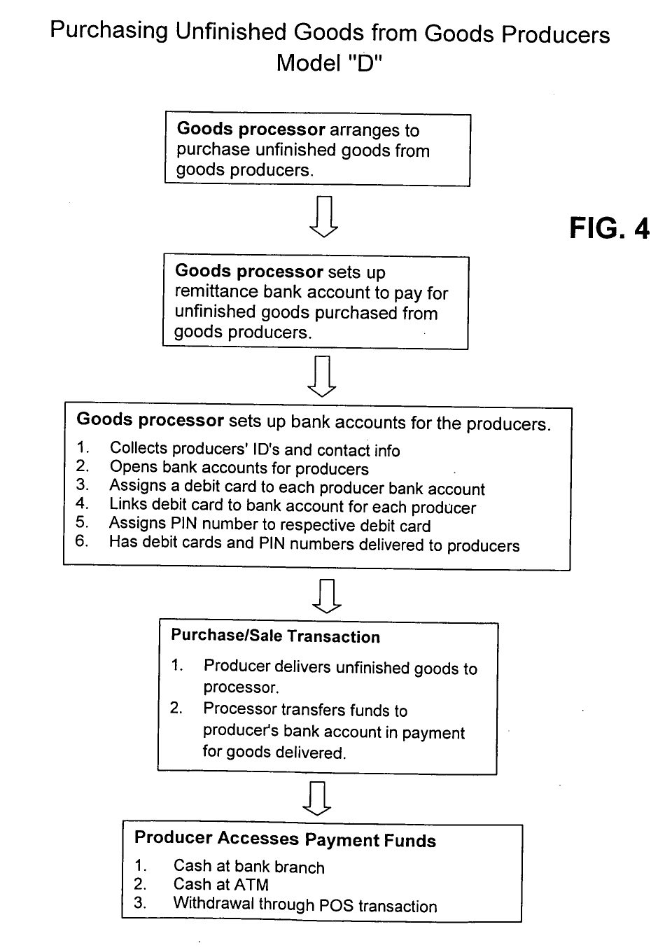

Referring to FIG. 4, the goods processor arranges to purchase unfinished goods from one or more producers of unfinished goods, including agreement regarding general procedure pertaining to where and when the goods producers will deliver the unfinished goods to the goods processor. Such agreement may be as simple as an oral agreement/contract, or can be a written contract. A wide variety of agreements are contemplated. Also a wide variety of types of unfinished goods are contemplated as being within the scope of the invention.

Substantial benefit to producers of unfinished goods are contemplated where rule of law is relatively less predictable, for example where a person carrying cash bears substantial risk of being robbed; also where it is common for producers of unfinished goods to not have a bank account where a check can be cashed, whereby payment by check is uncommon and payment in cash is relatively more common.

Typically such locations where the system of the invention will find substantial benefit are in locations where the unfinished goods are produced by self-employed workers such as small farmers and/or individual persons who produce goods using a learned trade or craft. Accordingly, the unfinished goods purchased are typically agricultural products or craft products, though other types of products can be so purchased as well.

A such producer is typically a single person or a single family, or a small number of persons working together in an informal e.g. collective arrangement, whereby the individual payments to any one producer are relatively small, and wherein the processor purchases goods from a relatively large number of producers. While the processor typically has no responsibility for the safety of the producer when payment has been made, anything the processor can do in arranging for a better financial environment for the producer strengthens the bond between the producer and the processor, and can facilitate the producer continuing to produce the unfinished goods, whereby the processor is further assured of a continuing supply of the unfinished goods from the respective producer.

Referring again to FIG. 4, the goods processor sets up a remittance bank account from which to pay producers of the desired unfinished goods, for the unfinished goods they produce.

The goods processor also takes responsibility for setting up a recipient bank account for each goods producer with whom the goods producer has an agreement to receive goods. In setting up the recipient bank accounts, the goods processor collects enough information to set up the producers bank account; such information as the identity of the producer, any required government registration information, the producers address and/or other contact information whereby identity and location of the goods producer can be verified to the satisfaction of banking requirements.

The goods processor then opens a bank account for the goods producer, and takes a bearer debit card from inventory and assigns the debit card, by card number, to the bank account now established in the name of the producer. Such opening of the bank account and assignment of the bearer debit card number can be done in person at a bank branch, but will more commonly be done remotely e.g. through an internet connection identified by the supplier of the inventory of debit cards for such purpose.

Still using e.g. an internet connection, the goods processor links the bank account to the debit card, and assigns a PIN access code to the debit card. Having finished the set-up of the bank account and having linked the bank account and the debit card together and assigned a PIN number, the goods processor then delivers the debit card to the producer, and separately delivers the PIN number to the goods producer to complete the set-up of the debit card payment system.

While not required, it is anticipated that the remittance bank account and the recipient bank accounts are set up with a single bank, whereby all funds transfers from the remittance account to recipient accounts are internal transfers within the single banking institution, which enhances the transparency of the transactions.

It is instructive to note that at no time is the goods producer required to enter any banking facility or any other building or facility operating as a bank, in order to receive the bank account and debit card set-up. Rather, all interaction with the banking institution is done by the goods processor, and even that interaction can be done entirely through the internet. Namely all accounts are set up, including for the goods producers, and the only interface the goods producer has with any bank connection is the receipt of the debit card from the goods processor who is typically an individual or entity in whom the goods producer has a significant level of trust.

With the payment system thus set up, as a goods producer periodically delivers his/her unfinished goods to the goods processor, the goods processor tallies the quantity and optionally the quality of the goods received, and calculates an amount of money payment which is due the producer of those unfinished goods under their purchase agreement, and may give the producer a receipt for the goods so received.

Such receipt of unfinished goods from the goods producer creates an obligation under the purchase/sale agreement whereby the goods processor is obligated to make a payment in the calculated amount to the goods producer. In fulfillment of that obligation, the goods processor instructs the bank, either by an in-person visit, through an internet instruction, a phone call to the bank, or a debit card transaction, to transfer the calculated amount of money from the processor's remittance account to the recipient account of the goods producer.

Once the payment has been so transferred to the recipient account, the goods producer can access the funds through transactions at any one or more of a branch of the bank, a POS or an ATM, using the combination of the debit card and the assigned PIN access number. Thus, given the POS and ATM options, the system is compatible with the aversion of some cultures to entering a banking facility per se, whereas no such cultural aversion attaches to POS terminals or ATM's. Accordingly, the goods producer can receive payment through conventional banking infrastructure while not being required to enter a conventional bank building.

In order to ensure that the goods processor has a clear record of payment receipts in the recipient bank account, the rule writer can be instructed to write the rules for use of the debit cards such that deposits into the debit card accounts are limited to payments received from the goods processors remittance account. The debit typically is an open-loop debit card whereby the goods producer can use the debit card to make payments or receive cash at any ATM or POS which is compatible with use of the card brand, e.g. Mastercard, VISA, Discover which is associated with the particular debit card.

Where the producer is a number of persons working together in a collective arrangement, the good processor makes payment to an account associated with the group. The group leader or representative distributes the funds from the group account to respective members of the group. As desired, the goods processor can set up financial accounts and debit cards for members of the group so as to facilitate distribution of the funds within the group. In such case, the goods processor deposits payments into the group account, and responsible persons within the group or entity distribute the funds from the group account to the accounts of the members of the group.

In a subset of embodiments, the debit card is a closed-loop card whose use to withdraw funds is limited to certain terminals specified by location or vendor identity, such as the processor's company store, or an ATM in the processor's company store, whereby the processor has more control over situations in which the card user is exposed to the hazards of the use of cash.

Since the processor is providing a service to the producers in setting up the bank accounts, in inventorying debit cards, in assigning debit cards to the producers, and in linking the debit cards to the bank accounts, the processor may sell the debit card service to the producers, both the initial set-up of the account and the ongoing maintenance of the account. While such option is not available to a conventional bank, the processor can act as the legitimizing organization, providing transparency to the respective transactions, such that the processor is permitted by existing laws, regulations, and rules to so act on behalf of the producers without the producers physically coming to a banking facility, or even being present with the processor when the respective bank account is being set up and the debit card assigned. Thus, the processor is acting in the stead of an employer in a payroll debit account, but is purchasing unfinished goods rather than labor services. Further, since money can be deposited into the account only by transfers from the processor's remittance account, the amount of funds which can be transferred, country-to-country, from the producer's recipient account will be limited to the amount of money transferred into such account by the processor.

Given that the good producer does not initially receive cash from the processor/purchaser of the goods, the payment system initially protects the producer from theft of cash money, and yet enables the producer to pay bills, to purchase goods and services, all without use of cash, while allowing the producer/user to access cash from e.g. an ATM when cash is a better option.

A significant feature of debit card accounts used by the processor and producer in this illustrated embodiment is the fact that the card account is being initiated, and the card is being distributed, by a non-banking entity, namely by the goods processor. Thus, although conventional banking infrastructure is used to set up the account and link the account to the debit card, no bank representative is actively involved in sale/distribution of the card. Since no bank facility or bank personnel are involved in setting up the account, the sales/distribution process is not subject to the full set of conventional banking regulations whereby special rules can be written for the respective debit cards, specific to the user's needs, and whereby bearer cards can be assigned to specific owners/users/accounts without the owners/users of the cards being physically present when the cards are activated.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. A debit card system, comprising:
(a) a non-financial-institution, non-employer, sponsor;
(b) an affinity group comprising at least first and second natural person remitters, affiliated with said sponsor by other than an employee-employer relationship;
(c) a card processor;
(d) financial institution accounts established for respective ones of said at least first and second natural person remitters, said accounts comprising, as to a such natural person remitter,
(i) a first remittance financial account at a first financial institution, associated with the respective natural person remitter, and
(ii) a second recipient financial account at a second financial institution, associated with a second legal entity recipient;
(e) a debit card linked to said second account, and adapted to deliver, through said second financial account, remittances received from said first financial account; and
(f) a PIN access number associated with said debit card thereby to enable the second legal entity to gain electronic access to said second account by use of said debit card and said PIN access number in combination, and thereby to enable the second legal entity to gain electronic access to funds remitted from said first account.

2. A debit card system as in claim 1, further comprising a second debit card, linked to said first financial account, and a second different PIN access number associated with said second debit card, and wherein optionally said first debt card and said second debt card bear a common brand identity.

3. A debit card system as in claim 1 wherein said debit card is one of a bearer debit card and an open loop debit card.

4. A debit card system as in claim 1 wherein the second legal entity is not said sponsor.

5. A debit card system as in claim 1 wherein the second legal entity recipient is a natural person.

6. A debit card system as in claim 1, further comprising a facilitating organization which facilitates gathering together a group of interested people for the sponsor, and wherein the facilitating organization is selected from the group consisting of government-recognized non-profit organizations such as social organizations, civic organizations, community organizations, spiritual organizations, and government-sponsored organizations; official government organizations; and for-profit business entities.

7. A debit card system as in claim 2, further comprising a tracking entity, adapted to receive tracking communications from said first financial institution, said tracking entity employing tracking software to identify and keep record of sources of funds transferred into said first financial account in addition to payroll and cash sources, wherein optionally the tracking software can distinguish the source of any funds deposited into the second account according to at least payroll, cash, or other financial accounts, and wherein optionally the tracking software can distinguish, as to the other financial accounts, between checking accounts, savings accounts, and money market accounts.

8. A debit card system as in claim 1 wherein said debit card, in combination with the PIN access number, is effective to activate receipt of a remittance at one or more of a point of sale terminal and an automatic teller machine.

9. A debit card system as in claim 1 wherein both of said first and second financial accounts are associated with a single financial institution.

10. A debit card system as in claim 1, including rules associated with the second recipient account which block such second recipient account from receiving funds from any source other than the first remittance account.

11. A method of setting up a monetary remittance system for a group of natural persons capable of benefitting, as a member group, from such remittance system, the method comprising:
(a) publicizing features of the remittance system to a targeted audience of natural persons and thereby encouraging such persons to engage with a sponsoring non-profit organization so as to gain additional information about such remittance system;
(b) providing additional information to persons responding to such publicizing thereby to obtain purchase decisions from at least some such responding natural persons, thus to convert such responding persons into purchasing members; and
(c) closing sales to such responding natural persons by, as to a such responding person,
(i) setting up a first primary remittance financial account in the name of the responding person, as remitter,
(ii) setting up a second recipient financial account at the request of the responding person, in the name of a second natural person, and without the presence of the second natural person,
(iii) assigning a debit card to such second natural person,
(iv) linking the debit card to the second recipient financial account, and
(v) assigning a PIN access number in association with the debit card thereby to enable electronic access to the second recipient financial account by using the debit card.

12. A method as in claim 11 wherein the publicizing is done by a facilitating organization in a relationship other than an employee-employer relationship with the targeted group of natural persons, and wherein optionally the facilitating organization receives payment for assisting in attracting persons of the targeted group into a relationship with the sponsoring organization.

13. A method as in claim 11, the debit card being effective to activate receipt of a remittance at one or more of a point of sale terminal or an automatic teller machine.

14. A method as in claim 11 wherein both of said first and second financial accounts are associated with a single financial institution.

15. A method as in claim 11 wherein rules associated with such recipient financial account block such second recipient account from receiving funds from any source other than such first remittance account.

16. A method as in claim 11 wherein the debit card is a bearer debit card.

17. A method as in claim 11, further comprising linking the first financial account to tracking software which tracks the source of each deposit, and enables receiving deposits from cash, from payroll deposits, and from other existing and identifiable financial institution accounts.

18. A method of transmitting a desired amount of money from a first location to a second different location, the method comprising:
(a) depositing into a first financial remittance account, which is not a payroll deposit account, at the first location in a first country, enough money to support transmitting the desired amount of money from the first location to the second location;
(b) effecting electronic transfer of the desired amount of money to a second different financial recipient account in the first country; and
(c) using a debit card, anywhere, withdrawing at least a portion of the transferred money from the second financial recipient account at the second location.

19. A method as in claim 18, comprising activating receipt of at least a portion of a remittance at one or more of a point of sale terminal in a second country or an automatic teller machine in the second country.

20. A method as in claim 18, further comprising linking the first financial account to tracking software adapted to track the source of each deposit, and enabling the first financial account to receive deposits from cash, from payroll deposits, and from other existing and identifiable financial institution accounts, and tracking each deposit into the first financial remittance account, according to cash, or payroll deposit, or other existing and identifiable financial institution accounts.

21. A method of marketing a monetary remittance system, comprising:
(a) identifying one or more target groups, wherein individual persons in a given such target group share a common interest, pertaining to making long distance money remittances from a first remitter person in a first country to at least a second receiving entity;
(b) setting up at least first and second community events, spaced from each other in at least one of space and time, wherein the locations are not at physical locations occupied by financial institution facilities, and wherein the events encourage attendees of such events to make purchases of services which activate accounts and systems capable of effecting monetary remittances from a first location to a person at a second location remote from the first location, wherein debit cards are used to receive such remittances;
(c) marketing the at least first and second community events to the identified one or more targeted groups and thus drawing responsive members of such target groups to at least one of such at least first and second community events;
(d) conducting the first community event at a first time and at a first location, including collecting a first set of information, and payments for services, from a first group of purchasers who attended such community event, and activating a first set of financial accounts and debit cards for such first group of purchasers, based on the first set of information so collected, including delivering debit cards to the named first recipient account holders; and
(e) conducting the second community event at a second time and/or a second location, including collecting a second set of information, and payments for services, from a second group of purchasers who attended such second community event, and activating a second set of financial accounts and debit cards from such second group of purchasers, based on the second set of information so collected, including delivering debit cards to the named second recipient account holders.

22. A method as in claim 21 wherein the financial accounts, as to a given purchaser comprise a first remittance account associated with the purchaser and a second recipient account associated with a second entity named by the purchaser.

23. A method as in claim 21, further comprising assigning a debit card, and associated PIN access number to the second recipient account, and wherein optionally rules associated with such second recipient account block such second recipient account from receiving funds from any source other than such first remittance account.

24. A method as in claim 21 wherein as to a given purchaser, the method comprises activating first and second such debit cards linked to the respective first and second financial accounts, and wherein the first debit card and the second debit card bear a common card brand identity.

25. A method of marketing a monetary remittance system, comprising:
(a) identifying one or more target groups, wherein individual persons in a given such target group share a common interest, pertaining to making monetary remittances from a first remitter person at a first location to at least a second receiving entity at a second location, remote from the first location, and wherein individual persons in such target group have existing trusted group-related relationships with a non-employer, government-recognized, facilitating entity which already interacts with persons in such target group; and
(b) marketing remittance services to such target group through one or more such trusted facilitating entity such that individual persons in such target group are encouraged by such one or more trusted facilitating entity to purchase such international remittance services either directly from such trusted facilitating entity or at a venue where such trusted entity has at least a temporary presence.

26. A method as in claim 25 wherein such trusted entity is a religious organization, or wherein such trusted entity is a for-profit non-financial business, and is not a debit-card processor.

27. A method as in claim 25, the method further comprising, as to a given such individual purchaser, setting up a first financial remittance account associated with the purchaser, and setting up a second financial recipient account associated with a second different legal entity, and linking a debit card and associated PIN access number with the second financial recipient account.

28. A method as in claim 27, further comprising assigning a second debit card to the first remittance account, and wherein the first debit card and the second debit card bear a common card brand identity.

29. A method as in claim 27 wherein rules associated with such second recipient account block such second account from receiving funds from any source other than the first financial remittance account.

30. A method by which a processor of unfinished goods, who purchases such unfinished from a group of producers of such unfinished goods, pays individual producers of such unfinished goods for purchases of such unfinished goods, the method comprising:
(a) setting up a first primary remittance financial account representing such processor of such unfinished goods;
(b) setting up multiple recipient financial accounts including at least one such recipient financial account representing each such producer of such unfinished goods;
(c) assigning debit cards to such producers of such unfinished goods and linking the debit cards to the recipient financial accounts;
(d) assigning PIN access numbers associated with the debit cards thereby to enable electronic access to funds in the recipient financial accounts;
(e) receiving and purchasing such unfinished goods from a such producer of such unfinished goods; and
(f) paying for such purchase of such unfinished goods by transferring an appropriate quantity of funds from the first primary remittance account to the recipient account representing the respective such producer of unfinished goods,
whereby the respective producer of such unfinished goods can access and use the funds so transferred by using the respective debit card and assigned PIN access number.

31. A method as in claim 30 wherein the goods are unfinished agricultural goods.

32. A method as in claim 30 wherein the debit cards are open loop debit cards.

33. A method as in claim 30, further comprising the processor of goods selling the debit cards to the producers of unfinished goods.

34. A method as in claim 30 wherein the method initially protects such producer of such unfinished goods from theft of cash money, and enables such producer of unfinished goods to pay bills, to purchase goods and services, without handling any cash, as well as to access cash.

35. A method as in claim 30 wherein rules associated with a such recipient account block the respective recipient account from receiving funds from any source other than such processor of unfinished goods.
